(19) United States
(12) Patent Application Publication
(10) Pub. No.: US 2025/0119701 A1
(43) Pub. Date: Apr. 10, 2025

(54) MODIFICATION OF SPATIAL AUDIO SCENES

(71) Applicant: Nokia Technologies Oy, Espoo (FI)

(72) Inventors: Lasse Juhani LAAKSONEN, Tampere (FI); Anssi Sakari RÄMÖ, Tampere (FI)

(21) Appl. No.: 18/903,563

(22) Filed: Oct. 1, 2024

(30) Foreign Application Priority Data
Oct. 6, 2023 (GB) 2315343.0

(51) Int. Cl. H04S 7/00; H04R 5/027

(52) U.S. Cl. CPC H04S 7/304; H04R 5/027; H04R 2499/13; H04S 2400/11; H04S 2400/15

(57) ABSTRACT

An apparatus comprising means for: identifying a sector of an audio scene, wherein the sector comprises one or more persons; and determining a modification to a spatial audio content, for rendering the audio scene, to reduce an angular offset between an orientation of the audio scene for rendering and an orientation of the identified sector.

### TECHNOLOGICAL FIELD

Examples of the disclosure relate to enabling a controlled modification of spatial audio scenes.

### BACKGROUND

Spatial audio refers to audio where audio sources are distinctly positioned, often in three dimensions. The positioning can be direction-only but can also be location (direction and distance).

A captured audio scene captures audio sources at different positions in an audio space. It is captured as spatial audio content using multiple microphones, such as a microphone array.

A rendered audio scene renders audio sources at different positions in a rendered audio space. It is rendered from spatial audio content using multiple speakers, e.g., using a loudspeaker setup or via a headphone. The headphone can have head-tracking capability. The audio rendered to a listener, the audio scene, depends upon a position and/or orientation of the listener in the rendered audio space, and in some examples this can track with the position and/or orientation of the listener in real space.

It would be desirable to improve the perception of an audio scene when rendered to a listener.

### BRIEF SUMMARY

According to various, but not necessarily all, examples there is provided an apparatus comprising means for:
identifying a sector of an audio scene, wherein the sector comprises one or more persons; and
determining a modification to a spatial audio content, for rendering the audio scene, to reduce an angular offset between a scene orientation of the audio scene for rendering and a sector orientation of the identified sector.

In some but not necessarily all examples, the scene orientation of the audio scene for rendering is defined by a front direction for rendering the audio scene and the sector orientation of the identified sector is defined by a midline of the sector.

In some but not necessarily all examples, the sector has an angular spread that does not extend beyond a spatial distribution of persons in the audio scene.

In some but not necessarily all examples, the means for identifying a sector of an audio scene comprising one or more persons is configured to identify the sector as an active sector and comprises means for processing audio content captured from the audio scene to identify a sector of the audio scene that actively includes speech audio sources.

In some but not necessarily all examples, the means for identifying a sector of an audio scene comprising one or more persons is configured to identify the sector as an active sector and comprises means for receiving an input from one or more person-presence-sensors for the audio scene that detect active physical presence of one or more persons in the sector of the audio scene.

In some but not necessarily all examples, the means for identifying a sector of an audio scene comprising one or more persons is configured to identify the sector as an active sector and comprises one or more in-vehicle person-presence-sensors configured to detect active physical presence of one or more persons in the sector of the audio scene, wherein the audio scene is an in-vehicle audio scene.

In some but not necessarily all examples, the one or more in-vehicle person-presence-sensors comprise vehicle seat weight sensors and/or vehicle seatbelt buckle activation sensors.

In some but not necessarily all examples, the means for determining a modification to a spatial audio content, for rendering the audio scene, to reduce an angular offset between a scene orientation of the audio scene and a sector orientation of the identified sector comprises means for rotating the audio scene.

In some but not necessarily all examples, the apparatus comprises modifying means for modifying the spatial audio content for rendering the audio scene, wherein the spatial audio content comprises at least a first audio source at a first orientation relative to the scene orientation of the audio scene and a second audio source at a second orientation relative to the scene orientation of the audio scene, wherein the modifying means is configured to reduce an angular offset between the first orientation and the scene orientation of the audio scene, and an angular offset between the second orientation and the scene orientation of the audio scene.

In some but not necessarily all examples, the modifying means is configured to modify the spatial audio content, such that the scene orientation of the audio scene is mid-way between the first orientation and the second orientation.

In some but not necessarily all examples, the means for determining a modification to a spatial audio content, for rendering the audio scene, to reduce an angular offset between a scene orientation of the audio scene and a sector orientation of the identified sector comprises modifying means for modifying the spatial audio content for rendering the audio scene, to optimize a cost function that favors a spaced, distribution of orientations of persons about the scene orientation of the audio scene.

In some but not necessarily all examples, the means for determining a modification to a spatial audio content, for rendering the audio scene, to reduce an angular offset between a scene orientation of the audio scene and a sector orientation of the identified sector comprises
means for determining a modification to a spatial audio content, for rendering the audio scene, to reduce to zero an angular offset between the scene orientation of the audio scene and the sector orientation of the identified sector.
or
means for determining a modification to a spatial audio content, for rendering the audio scene, to reduce to a non-zero value an angular offset between the scene orientation of the audio scene and the sector orientation of the identified sector.

In some but not necessarily all examples, microphones used for capturing the spatial audio from an audio scene are fixed relative to the audio scene and wherein the means for determining a modification to a spatial audio content, for rendering the audio scene, to reduce an angular offset between a scene orientation of the audio scene and a sector orientation of the identified sector comprises means for virtually re-orienting the microphones.

In some but not necessarily all examples, the apparatus is configured to transfer a modification record of the modification on the spatial audio content to reduce a difference between the orientation of the audio source and the scene orientation of an audio scene, to enable the modification to be done or undone.

According to various, but not necessarily all, examples there is provided a method comprising:
identifying a sector of an audio scene, wherein the sector comprises one or more persons; and
determining a modification to a spatial audio content, for rendering the audio scene, to reduce an angular offset between a scene orientation of the audio scene for rendering and a sector orientation of the identified sector.

According to various, but not necessarily all, examples there is provided a computer program comprising instructions that when executed by one or more processors causes:
identifying a sector of an audio scene, wherein the sector comprises one or more persons; and
determining a modification to a spatial audio content, for rendering the audio scene, to reduce an angular offset between a scene orientation of the audio scene for rendering and a sector orientation of the identified sector.

According to various, but not necessarily all, examples there is provided an apparatus comprising means for:
identifying a sector of an audio scene, wherein the sector comprises one or more persons;
determining a modification to a spatial audio content, for rendering the audio scene, to reduce an angular offset between a scene orientation of the audio scene for rendering and a sector orientation of the identified sector; and
modifying spatial audio content, for rendering the audio scene, in dependence upon the determined modification to reduce, in a rendered audio scene, an angular offset between a scene orientation of the rendered audio scene and a sector orientation of the identified sector.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

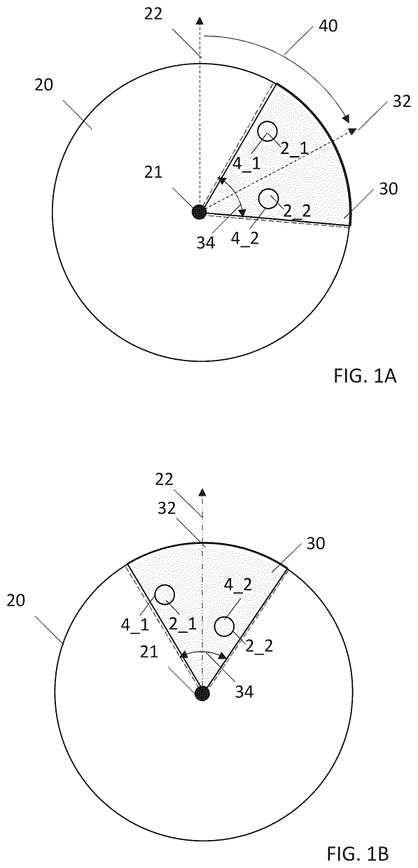

FIG. 1A illustrates an example of an audio scene 20 before modification and FIG. 1B illustrates the audio scene 20 after modification;

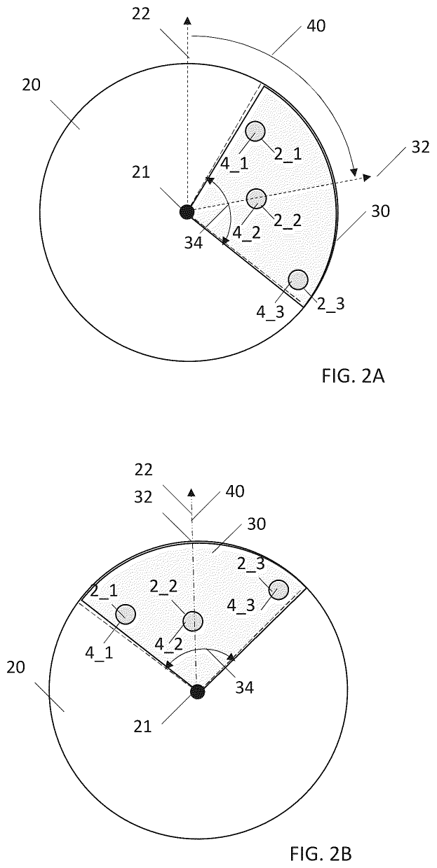

FIG. 2A illustrates an example of an audio scene 20 before modification and FIG. 2B illustrates the audio scene 20 after modification using a cost function;

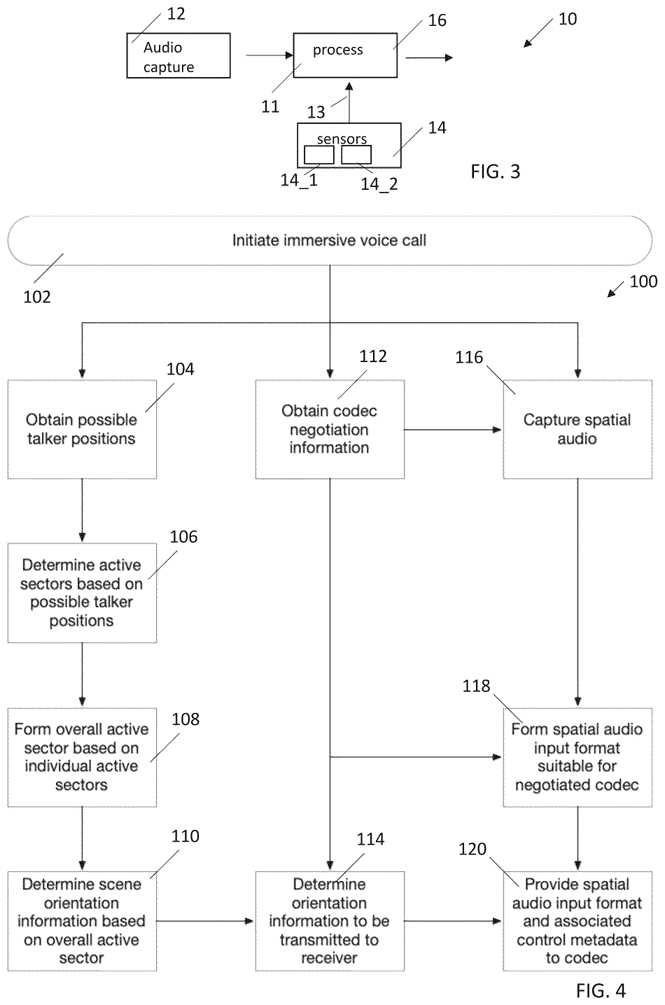

FIG. 3 illustrates an example of an apparatus 10 for determining a modification to spatial audio content to modify a rendered spatial audio scene;

FIG. 4 illustrates a method 100 of adaptive spatial audio capture including determining a modification to spatial audio content to modify a rendered spatial audio scene;

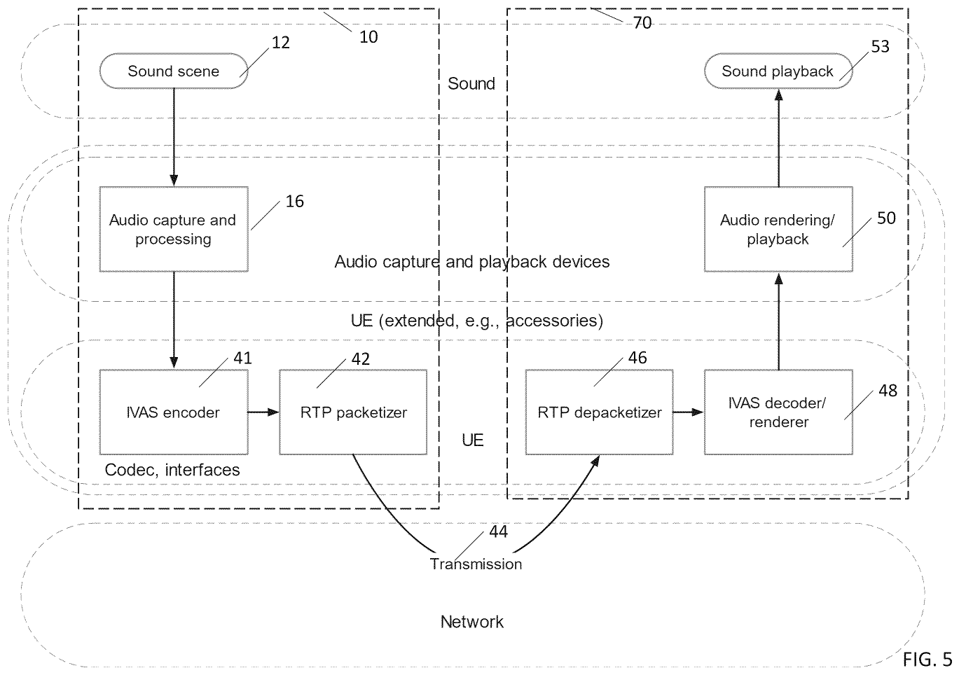

FIG. 5 illustrates an example of system suitable for performing a telecommunication session such as an immersive voice call;

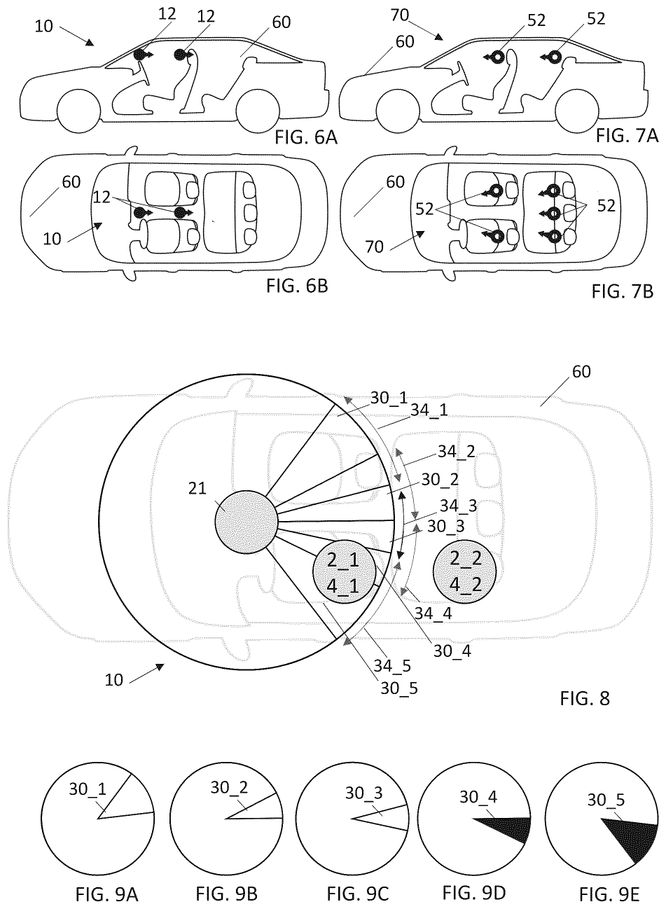

FIGS. 6A and 6B illustrate, using two different views of the same vehicle, an example of in-vehicle spatial audio capture and FIGS. 7A and 7B illustrate, using two different views of the same vehicle, an example of in-vehicle spatial audio rendering;

FIGS. 8 and 9A-9E illustrate the use of sectors for in-vehicle audio capture;

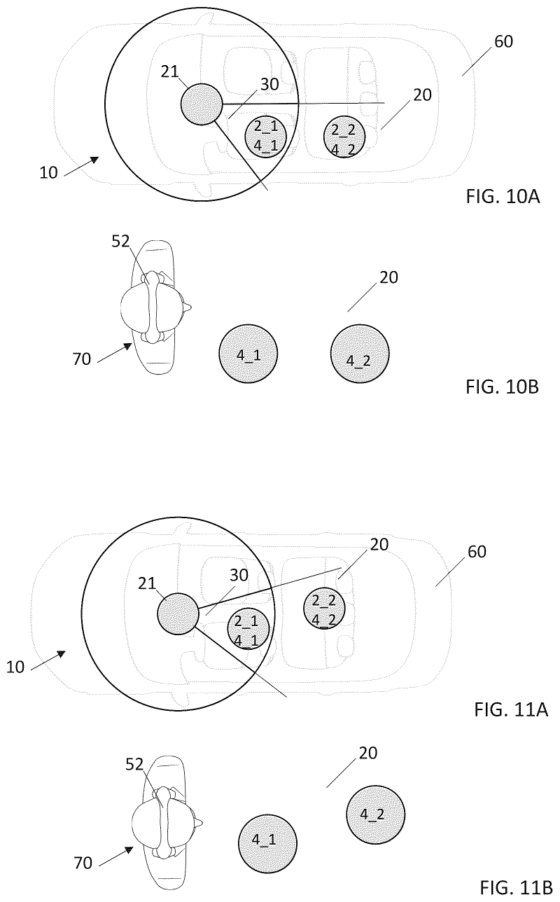

FIG. 10A illustrates an original in-vehicle sound scene as captured as captured from a frontal microphone array;

FIG. 10B illustrates the original in-vehicle sound scene rendered without modification;

FIG. 11A illustrates a modification to the original in-vehicle sound scene;

FIG. 11B illustrates the in-vehicle sound scene rendered with the modification;

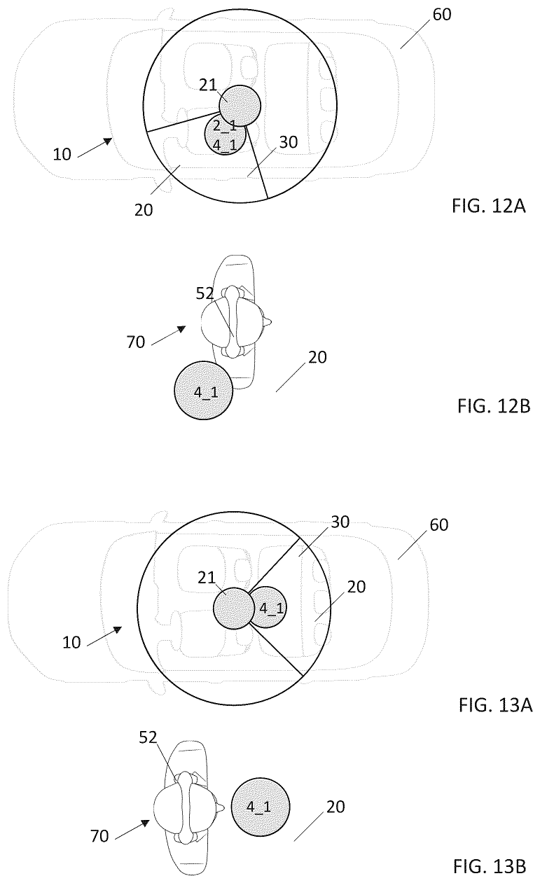

FIG. 12A illustrates an original in-vehicle sound scene as captured from a central microphone array;

FIG. 12B illustrates the original in-vehicle sound scene rendered without modification;

FIG. 13A illustrates a modification to the original in-vehicle sound scene;

FIG. 13B illustrates the in-vehicle sound scene rendered with the modification;

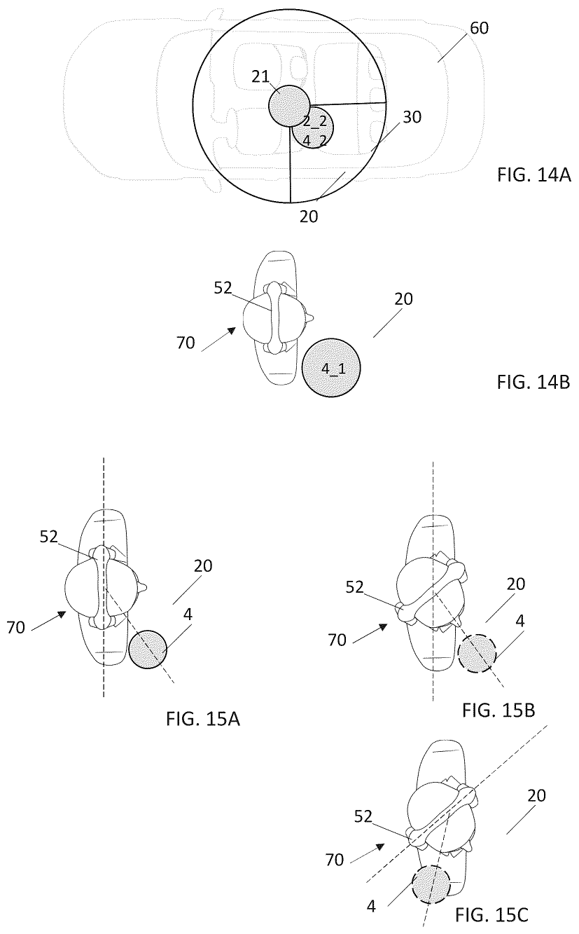

FIG. 14A illustrates a different modification to the original in-vehicle sound scene;

FIG. 14B illustrates the in-vehicle sound scene rendered with the different modification;

FIGS. 15A, 15B and 15C illustrates an example of rendering an audio scene using headphones 52 with head-tracking (FIG. 15A, 15B) and without head-tracking (FIG. 15A, 15C);

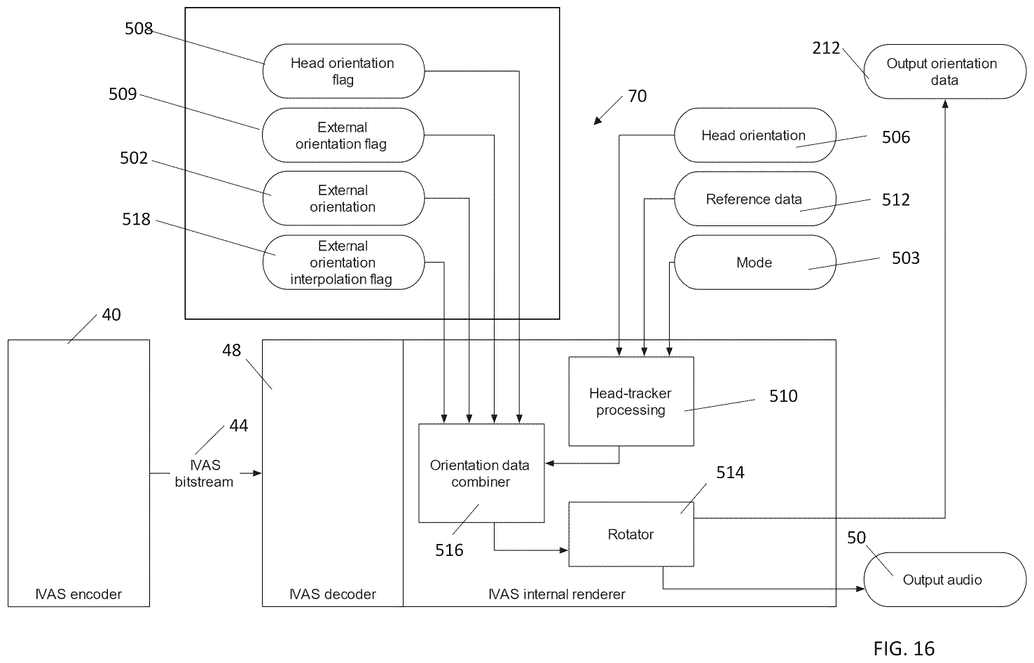

FIG. 16 illustrates an example using an IVAS decoder/renderer;

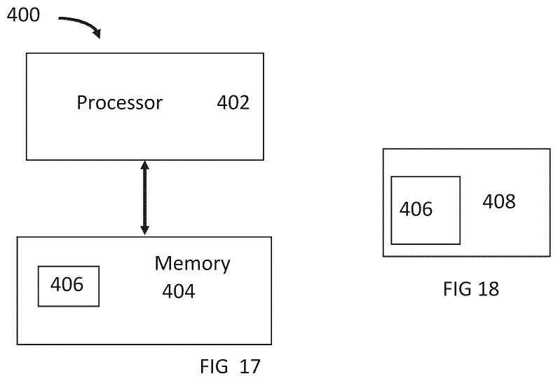

FIG. 17 illustrates an example of a controller 400 suitable for determining and/or applying the modification;

FIG. 18 illustrates an example of a computer program suitable for determining and/or applying the modification;

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 10) and a specific instance of the class (member of the set) can be referenced using the reference number with a numerical type subscript index (e.g. 10_1) and a non-specific instance of the class (member of the set) can be referenced using the reference number with a variable type subscript index (e.g. 10_i).

### DETAILED DESCRIPTION

Spatial audio refers to audio where audio sources are distinctly positioned, often in three dimensions. The positioning can be direction-only but can also be location (direction and distance).

A captured audio scene captures audio sources at different positions in an audio space. It is captured as spatial audio content using multiple microphones, such as a microphone array.

A rendered audio scene renders audio sources at different positions in a rendered audio space. It is rendered from spatial audio content using multiple speakers, e.g., using a loudspeaker setup or via a headphone.

The headphone can have head-tracking capability. The audio rendered to a listener, the audio scene, depends upon a position and/or orientation of the listener in the rendered audio space, and in some examples this can track with the position and/or orientation of the listener in real space.

Channel-based audio, for example, n·m surround sound (e.g. 5.1, 7.1 or 22.2 surround sound) or binaural audio, can be used or scene-based audio, including spatial information about a sound field and audio sources, can be used.

Audio content may encode spatial audio as audio objects. Examples include but are not limited to MPEG-4 and MPEG SAOC. MPEG SAOC is an example of metadata-assisted spatial audio.

Audio content may encode spatial audio as audio objects in the form of moving virtual loudspeakers.

Audio content may encode spatial audio as audio signals with or without parametric side information or metadata. The audio signals can be, for example, First Order Ambisonics (FOA) or its special case B-format, Higher Order Ambisonics (HOA) signals or mid-side stereo. For such audio signals, synthesis which utilizes the audio signals and the parametric metadata (if any) is used to synthesize the audio scene so that a desired spatial perception is created.

The parametric metadata may be produced by different techniques. For example, spatial audio capture or Directional Audio Coding (DirAC) can be used. Both capture a sound field and represent it using parametric metadata. The parametric metadata may for example comprise: direction parameters that indicate direction per frequency band; energy-split parameters that indicate diffuse-to-total energy ratio per frequency band. Each time-frequency tile may be treated as an audio source with the direction parameter controlling vector-base amplitude panning (VBAP) for a direct version and the energy-split parameter controlling gain for an indirect (decorrelated) version.

In some embodiments, the parametric audio metadata may relate to a metadata-assisted spatial audio (MASA) format.

Metadata-assisted spatial audio (MASA) uses audio signal(s) together with corresponding spatial metadata. The spatial metadata comprises parameters which define the spatial aspects of the audio signals and which may contain for example, directions and direct-to-total energy ratios in frequency bands. The MASA stream can, for example, be obtained by capturing spatial audio with microphones of a suitable capture device. For example a mobile device comprising multiple microphones may be configured to capture microphone signals where the set of spatial metadata can be estimated based on the captured microphone signals. The MASA stream can be obtained also from other sources, such as specific spatial audio microphones (such as Ambisonics), studio mixes (for example, a 5.1 audio channel mix) or other content by means of a suitable format conversion.

3GPP IVAS (3GPP, Immersive Voice and Audio services) and MPEG-I, which are currently under development and standardization, support new immersive voice and audio services, for example, mediated reality.

The Immersive Voice and Audio Services (IVAS) codec has been designed to be suitable for use over a communications network such as a 3GPP 4G/5G network including use in such immersive services as for example immersive voice and audio for virtual reality (VR). This audio codec handles the encoding, decoding, and rendering of speech, music, and generic audio. It furthermore supports channel-based audio and scene-based audio inputs including spatial information about the sound field and audio sources, i.e., Metadata-assisted spatial audio (MASA) and object-based audio (or independent streams with metadata, ISM). The codec operates with low latency to enable conversational services. It also supports high error robustness under various transmission conditions. The IVAS codec supports rendering for loudspeaker setups and binaural presentation, including head-tracked binaural rendering.

In some but not necessarily all examples amplitude panning techniques may be used to create or position an audio object or source. For example, the known method of vector-base amplitude panning (VBAP) can be used to position an audio source.

An audio object may be re-positioned by mixing a direct form of the object (an attenuated and directionally-filtered direct sound) with an indirect form of the object (e.g. positioned directional early reflections and/or diffuse reverberant). An audio source appears closer if it is louder and less reverberant and appears further away if it is quieter and more reverberant.

In some but not necessarily all examples, an IVAS MASA bitstream can be binaurally rendered using the integrated IVAS parametric binaural renderer. In further examples, external rendering such as a stand-alone binaural renderer can be used.

Spatial audio capture is possible using various means.

For example, a multi-microphone device such as a smartphone can use parametric capture to analyze and process the input signals and derive a parametric spatial audio format or synthesize some other spatial audio format. Metadata-assisted spatial audio (MASA) is a parametric spatial audio format.

Ambisonics is a spatial audio format that is non-parametric. A spherical microphone array such as an Ambisonics microphone array can be used to capture First-order Ambisonics (FOA) or Higher-order Ambisonics (HOA) spatial audio. Often, FOA/HOA is also called Scene-Based Audio (SBA).

A common characteristic with both the parametric spatial audio formats (MASA) and scene-based audio (FOA/HOA or SBA) is that they represent an audio scene around the capture point (the origin), which is typically understood as the center point of the microphone array or center point of the corresponding transport channels.

The 3GPP IVAS (Immersive Voice and Audio Services) codec is currently under standardization and will support both MASA and SBA input formats as well as, e.g., stereo, independent stream with metadata (ISMs), or audio objects.

Both MASA and SBA formats have a default format orientation, i.e., the front of the audio scene corresponds to a certain direction in the captured scene. It can however be desirable to render a different part of the audio scene as front to a listener. This can be called scene orientation.

FIG. 1A illustrates an example of an audio scene 20 before modification and FIG. 1B illustrates the audio scene 20 after modification.

The audio scene 20 comprises one or more persons 2. In this example it comprises two persons 2_1, 2_2.

Each person 2 is an audio source 4 or a potential audio source. In this example, there is an audio source 4_1 associated with speech from the person 2_1 and there is an audio source 4_2 associated with speech from the person 2_2.

The audio scene 20 has a scene orientation 22 of the audio scene 20. In some but not necessarily all examples, this scene orientation 22 is aligned with a notional point of view of a listener.

The audio scene 20 comprises a sector 30. The sector 30 of the audio scene 20 comprises the one or more persons 2_1, 2_2 (and the one or more associated audio sources 4_1, 4_2). The sector 30 has an orientation 32, a sector orientation.

If an audio scene 20 represents a captured audio scene, then the spatial audio content captured by microphones defines the direction (and possibly the position) of the input audio sources 4_1, 4_2 relative to an origin 21 of the audio scene 20.

If an audio scene 20 represents a rendered audio scene, then the spatial audio content rendered defines the direction (and possibly the position) of the output audio sources 4_1, 4_2 relative to an origin 21 of the audio scene 20.

As can be seen from FIG. 1A, before audio scene modification, there is an angular offset 40 between the scene orientation 22 of the audio scene 20 and the sector orientation 32 of the sector 30. As can be seen from FIG. 1B, after audio scene modification, the angular offset 40 between the scene orientation 22 of the audio scene 20 and the sector orientation 32 of the sector 30 is reduced.

In the example illustrated, the angular offset 40 is reduced to a zero offset, but other values are possible.

To achieve this outcome:
(i) a sector 30 of an audio scene 20 is identified. The sector 30 comprises one or more persons 2_1, 2_2.
(ii) a modification to a spatial audio content, for rendering the audio scene 20, is determined to reduce an angular offset 40 between a scene orientation 22 of the audio scene 20 and a sector orientation 32 of the identified sector 30.

The modification is used to render the audio scene 20 with the reduced angular offset 40 between the scene orientation 22 and the sector orientation 32.

In this example, the scene orientation 22 of the audio scene 20 is defined by a front of scene direction for rendering the audio scene 20 and the sector orientation 32 of the identified sector 30 is defined by a midline of the sector 30. The sector 30 has an angular spread 34 and the sector orientation 32 of the sector 30 is bisected by the midline of the sector.

In this example, the audio scene 20 defined by the spatial audio content comprises at least a first audio source 4_1 at a first orientation relative to the scene orientation 22 of the audio scene 20 and a second audio source 4_2 at a second orientation relative to the scene orientation 22 of the audio scene 20. A sum of a first angular offset between the first orientation and the scene orientation 22, and a second angular offset between the second orientation and the scene orientation 22 is reduced between FIGS. 1A and 1B.

In this example, the first audio source 4_1 is rotated about the origin 21 and the second audio source 4_2 is rotated about the origin. In this example, but not necessarily all examples, the first audio source 4_1 is rotated about the origin 21 in a first sense by a first amount and the second audio source 4_2 is rotated about the origin in the first sense by the first amount.

The rotations places the scene orientation 32 mid-way between the first orientation and the second orientation such that the first audio source 4_1 is positioned to one side (left-side) of the scene orientation 22 and the second audio source 4_2 is positioned to the other side (right-side) of the scene orientation 22.

A sum of a first angular offset between the first orientation and the scene orientation, and a second angular offset between the second orientation and the scene is reduced between FIGS. 1A and 1B.

In this example, but not necessarily all examples, the angular offset 40 between the scene orientation 22 of the audio scene 20 and the sector orientation 32 of the identified sector 30 is common rotation provided by a scene rotation of the audio scene about the origin 21 of the audio scene 20, as illustrated in FIG. 1B. The positional relationship between the audio sources 4 within the sector 30 is maintained and is not changed by the modification. The sector 30 retains it audio integrity. The modification instead rotates the sector 30 about the origin 21.

FIGS. 2A and 2B illustrate an example similar to that illustrated in FIGS. 1A and 1B and the description provided above is relevant to these Figs also. FIG. 2A illustrates before modification of the audio scene 20 and FIG. 2B illustrates after modification of the audio scene 20. In this example, the audio scene 20 comprises multiple persons 2 and multiple associated audio sources 4. Each person 2 is an audio source 4 or a potential audio source.

The audio scene 20 has a scene orientation 22 of the audio scene 20. In some but not necessarily all examples, this scene orientation 22 is aligned with a notional point of view of a listener.

The audio scene 20 comprises a sector 30. A sector 30 of the audio scene 20 is identified that comprises the multiple persons 2_1, 2_2, 2_3 (and the associated audio sources 4).

As can be seen from FIG. 2A, before modification, there is an angular offset 40 between the scene orientation 22 of the audio scene 20 and the sector orientation 32 of the sector 30. In FIG. 2B, after modification, the angular offset 40 between the scene orientation 22 of the audio scene 20 and the sector orientation 32 of the sector 30 is reduced. In the example illustrated, the angular offset 40 is reduced to a zero offset, but other values are possible.

To achieve this outcome:
(i) a sector 30 of an audio scene 20 is identified. The sector 30 comprises multiple persons 2. The sector 30 has an angular spread 34 dependent upon a spatial distribution of persons 2 in the audio scene.
(ii) a modification to a spatial audio content, for rendering the audio scene 20, is determined to reduce an angular offset 40 between a scene orientation 22 of the audio scene 20 for rendering and a sector orientation 32 of the identified sector 30.

The modification is then used to render the audio scene 20 with the reduced angular offset 40 between the scene orientation 22 and the sector orientation 32.

The identification of the sector 30 of the audio scene 20 and an amount of rotation of the audio scene can be determined based on optimization of a cost function where optimization of the costs function favors a spaced, distribution of orientations of persons 2 about the scene orientation 22. The cost function can also, in some examples, maintain the relative spatial distribution between persons 2 in the audio scene 20.

Optimization of the cost function, reduces the angular offset 40 between the scene orientation 22 of the audio scene 20 and the sector orientation 32 of the sector 30 and improves the balance of the audio scene. In the example illustrated, the audio sources 4_i associated with the persons 2_i are positioned more to the front (determined by the scene orientation 22) and to both the left and right of the front direction (determined by the scene orientation 22).

For example if each audio source S_i has an audio source orientation (α_i, β_i) relative to the scene orientation 22 then minimize

$${\sum }_{i} F ( {α}_{i} , {β}_{i} )$$

$$Where , for example F = sin ( ( α\_i ) * sin ( β\_i ) or$$

$$F = [ sin ( ( α\_i ) * sin ( β\_i ) ] \hat{} n , where n > 1$$

In some examples the cost function can be a weighted cost function, with the weights being dependent upon a characteristic of the audio source S_i, for example, average energy or percentage of time producing audio.

$$e . g . F = w\_i * sin ( ( α\_i ) * sin ( β\_i ) or$$

$$F = w\_i * [ sin ( ( α\_i ) * sin ( β\_i ) ] \hat{} n$$

FIG. 3 illustrates an example of an apparatus 10 comprising means 16 for identifying a sector 30 of an audio scene 20, wherein the sector 30 comprises one or more persons 2_1, 2_2; and
determining a modification to a spatial audio content, for rendering the audio scene 20, to reduce an angular offset 40 between a scene orientation 22 of the audio scene 20 for rendering and a sector orientation 32 of the identified sector 30.

In some but not necessarily all examples, the apparatus 10 additionally comprises modifying means configured to reduce an angular offset between the scene orientation 22 of the audio scene 20 and the sector orientation 32 of the identified sector 30.

The means 16 for identifying a sector 30 of an audio scene comprising one or more persons 2, comprises processing means, for example a controller.

In some examples, the processing means 16 is configured to process spatial audio content 11 captured by microphones 12 from the audio scene 20 to identify a sector 30 of the audio scene that includes speech audio sources 4.

In some examples, the processing means 16 is additionally or alternatively configured to process an input 13 from one or more person-presence-sensors 14 for the audio scene 20 that detect physical presence of one or more persons in the audio scene 20.

In some examples, the person-presence-sensors 14 are sensors that detect when a person is present at a particular location, for example sitting on a particular seat.

In some examples, the person-presence-sensors 14 are in-vehicle person-presence-sensors configured to detect physical presence of persons in the audio scene, where the audio scene is an in-vehicle audio scene. The in-vehicle person-presence-sensors are configured to detect physical presence of persons in the vehicle. In some examples, the in-vehicle person-presence-sensors comprise vehicle seat weight sensors 14_1 and/or vehicle seatbelt buckle activation sensors 14_2.

In some examples, the person-presence-sensors 14 comprise a camera and computer vision techniques are used to identify the presence of a person at a particular position.

FIG. 4 illustrates a method 100 of adaptive spatial audio capture as previously described in relation to FIGS. 1A and 1B and FIGS. 2A and 2B. The method can for example be performed by the apparatus 10.

The method comprises: identifying 104, 106, 108 a sector of an audio scene 20, wherein the sector comprises one or more persons 2; and determining 114 a modification to a spatial audio content 11, for rendering the audio scene 20, to reduce an angular offset between a scene orientation 22 of the audio scene 20 and a sector orientation 32 of the identified sector 30.

The modification may only be used subsequently if it is significant enough, for example larger than a threshold value.

In more detail, an immersive voice call is initiated at block 102.

At block 112, the method 100 comprises obtain codec negotiation information that identifies the selected spatial audio coding format.

In some but not necessarily all examples, codec negotiation information refers to, e.g., Session Description Protocol (SDP) parameters defining, e.g., encoder input format(s) supported by the transmitting device, bandwidth, etc.

At block 116, the method 100 comprises capturing spatial audio.

At block 118, the method 100 comprises forming a spatial audio input format suitable for the negotiated codec information.

At block 104, the method 100 comprises obtaining possible positions of persons (possible talkers).

At block 106, the method 100 comprises determining active sectors based on the obtained positions.

In some examples, a sector is identified as an active sector of an audio scene in dependence upon determination that the sector of the audio scene actively (currently) comprises one or more persons. The active sector is an active-presence sector.

In some examples, a sector is identified as an active sector of an audio scene in dependence upon determination that the sector of the audio scene currently comprises one or more persons who are actively (currently) speaking. The active sector is an active-speaking sector.

In some examples, for example in a vehicle, a seat can be occupied by a person but the person is not speaking or has not spoken recently. In this case, the sector associated with this seat could be determined not to be active because although it is an active-presence sector (e.g. based on a seat sensor) it is not an active-speaking sector (e.g. based on captured audio analysis).

In some examples, means for identifying a sector of an audio scene comprising one or more persons is configured to identify the sector as an active sector and comprises means for processing audio content captured from the audio scene to identify a sector of the audio scene that actively includes speech audio sources.

In some examples, means for identifying a sector of an audio scene comprising one or more persons is configured to identify the sector as an active sector and comprises means for receiving an input from one or more person-presence-sensors for the audio scene that detect active physical presence of one or more persons in the sector of the audio scene.

In some examples, means for identifying a sector of an audio scene comprising one or more persons is configured to identify the sector as an active sector and comprises one or more in-vehicle person-presence-sensors configured to detect active physical presence of one or more persons in the sector of the audio scene, wherein the audio scene is an in-vehicle audio scene. In some examples, the one or more in-vehicle person-presence-sensors comprise vehicle seat weight sensors and/or vehicle seatbelt buckle activation sensors.

At block 112, the method 100 comprises forming an overall active sector 30 based on the individual active sectors.

The method 100 therefore comprises: identifying 104, 106, 108 a sector 30 of an audio scene, wherein the sector comprises one or more persons.

At block 110, the method comprises determining audio scene orientation information based on overall active sector 30.

At block 114, the method comprises determining modification information based on the sector orientation 32 of the overall active sector 30. The block 114 determines a modification required to reduce an angular offset 40 between the scene orientation 22 of the audio scene 20 and a sector orientation 32 of the identified sector 30.

The method 100 therefore comprises determining 114 a modification to a spatial audio content, for rendering the audio scene, to reduce an angular offset 40 between a scene orientation 22 of the audio scene and a sector orientation 32 of the identified sector 30.

In one implementation, the determined modification to the spatial audio content, can be stored as a modification record of the modification to be performed on the spatial audio content to reduce a difference between the orientation of the audio source and the scene orientation of an audio scene, to enable the modification to be done elsewhere. The determined modification and the spatial audio content are transferred from the apparatus 10 to enable the modification of the spatial audio scene to be performed downstream after the transfer, at or after a receiver.

In another implementation, the spatial audio content is modified by the apparatus 10 in processing means 16 to reduce a difference between the sector orientation 32 of the sector 30 and the scene orientation 22 of an audio scene 20. The determined modification to the spatial audio content, can be stored as a modification record of the modification performed on the spatial audio content to reduce a difference between the orientation of the audio source and the scene orientation of an audio scene, to enable the modification to be undone downstream after the transfer, at or after a receiver. The determined modification and the modified spatial audio content are transmitted to enable use of the modified spatial audio scene, or if desired the recovery of the original spatial audio scene before modification.

In some examples, the modification determination can be substantially continuous or, e.g., periodical. Some smoothing of the scene orientation update can be used. In some examples, the method 100 is performed when a telecommunication session is initiated. In some examples, the method 100 is performed when a new person speaks in an on-going telecommunication session. In some examples, the method 100 is performed when a new person joins an on-going telecommunication session. A telecommunication session enables transfer or exchange of speech at a distance. An example is an immersive voice call.

From the forgoing it will be appreciated that apparatus 10 can comprise means for: identifying an active sector of an audio scene, wherein the active sector, at least, comprises one or more persons;
determining a modification to a spatial audio content, for rendering the audio scene, to reduce an angular offset between a scene orientation of the audio scene for rendering and a sector orientation of the identified active sector; and
modifying spatial audio content, for rendering the audio scene, in dependence upon the determined modification to reduce, in a rendered audio scene, an angular offset between a scene orientation of the rendered audio scene and a sector orientation of the identified active sector.

The method 100 can be dynamic and continuous, such that changes to the active sectors are recognized, in real time, and there is a consequential, corresponding change to the modification of the spatial audio. Thus active sectors can be dynamically added and/or removed in dependence upon the presence/activity of persons.

FIG. 5 illustrates an example of system suitable for performing a telecommunication session such as an immersive voice call. In this example, the transfer is the transmission 44 of information from a capture system (e.g. apparatus 10) to a render system (e.g. apparatus 70).

The capture system (e.g. apparatus 10) has been described in the preceding Figs.

In this example, the spatial audio content (modified or unmodified) and the determined modification are transferred by the capture system 10 to the render system 70 using an IVAS (Immersive Voice and Audio services) codec.

The determined modification can for example be encoded as a scene orientation update signaling, which is supported by the upcoming IVAS codec.

As described previously, the capture system 10 captures the audio scene 20 using microphones 12. The capture system 10 also determines the modification performed on (or to be performed on) the spatial audio content to reduce a difference between the sector orientation 32 of an identified sector 30 comprising persons 2 and the scene orientation 22 of the captured audio scene 20.

A sector 30 of an audio scene 20 is identified. The sector 30 comprises one or more persons 2_1, 2_2. A modification to spatial audio content, for rendering the audio scene 20, is determined to reduce an angular offset 40 between a scene orientation 22 of the audio scene 20 for rendering and a sector orientation 32 of the identified sector 30.

The spatial audio content (modified or unmodified) and the determined modification are encoded by the IVAS encoder 41. The resulting bitstream is packetized by RTP (Real-time Transport Protocol) packetizer 42 for transmission over a wireless network link 44.

The render apparatus 70 receives the packets transferred over the wireless network link 44. The received packets are depacketized to frames by the RTP depacketizer 46. The frames are decoded by the IVAS decoder/renderer 48. The IVAS decoder/renderer 48 enables the rendering of a modified audio scene 20 that reduces an angular offset 40 between the original orientation 22 of the audio scene 20 and the original orientation 32 of the identified sector 30. The modification of the audio scene can be performed at the render apparatus 70 using the received modification.

The spatial audio data is coded and rendered for playback on a specific system e.g. for binaural audio playback at headphones 52.

Optionally, the rendering can be achieved by an external renderer 50 (and not the IVAS renderer), e.g., manufacturer's own renderer.

The receiving user listens to the immersive voice call on their headphones. The user may, e.g., select between the original audio scene orientation or the modified audio scene orientation with improved spatial balance.

When the scene orientation information is taken into account, the receiving user is rendered the spatial audio scene with improved spatial balance, which improves the user experience by making it easier for the user to distinguish between the talker directions.

In some examples, the spatial audio capture environment can have more than one spatial audio capture array. A high-end vehicle could have multiple arrays. In this case, the selection between a first and a second array can be at least partially based on the obtaining of the possible talker positions.

FIG. 5 illustrates different stages using dotted lines. These stages can be performed in different apparatus or in the same apparatus.

For example, the audio scene capture by microphones 12 can be performed by an accessory apparatus or by in-vehicle apparatus. For example, the processing 16 can be performed by an accessory apparatus, a user's user equipment (UE) or by in-vehicle apparatus. For example, the IVAS encoding can be performed by a user's user equipment (UE) or by in-vehicle user equipment (UE).

For example, the audio scene playback 53 can be performed by an accessory apparatus (e.g. headphones) or by in-vehicle apparatus. For example, the rendering 50 can be performed by an accessory apparatus, a user's UE or by in-vehicle apparatus. For example, the IVAS decoding can be performed by a user's UE or by in-vehicle UE.

In some examples, the spatial audio capturing system 10 is for a first user and the spatial audio rendering system 70 is for a second user. In some examples, the spatial audio capturing system 10 is for a second user and the spatial audio rendering system 70 is for a first user. In some examples, a single system (or apparatus) can operate as spatial audio capturing system 10 and spatial audio rendering system 70 for a first user and a single system (or apparatus) can operate as spatial audio capturing system 10 and spatial audio rendering system 70 for a second user.

In at least some examples the microphones 12 used for capturing the spatial audio from an audio scene are fixed relative to the audio scene 20. In this situation, the processing 16 that determines a modification to a spatial audio content, for rendering the audio scene, to reduce an angular offset between a scene orientation 22 of the audio scene 20 and a sector orientation 32 of the identified sector 30 comprises means for virtually re-orienting the microphones.

During audio capture it is not possible to control the position of persons 2. However, in a controlled environment, persons may be expected to be static, e.g., not expected to move around the capture point origin 21. The possible talker positions are understood and can to be assumed substantially static relative to the capture point. Aspects of the audio scene 20 can be understood based in part on having information about where (possible) talkers are that, where persons 2 are.

In the following examples, the spatial audio capture environment is a vehicle 60, specifically a cabin of a car. However, the examples described relate to any substantially static spatial audio capture setup, e.g., in a conference room, a living room setup, etc.

The microphones 12 used for capturing the spatial audio from an audio scene 20 are fixed relative to the vehicle 60 in the interior of the cabin.

In the example illustrated in FIGS. 6A and 6B (audio capture) and FIGS. 7A and 7B (audio rendering) there is audio hardware, processing hardware, coding hardware, and communication hardware. These can be in the same or different apparatus 10, 70 e.g. audio hardware can be an in-vehicle accessory or UE e.g. processing hardware can be an in-vehicle accessory or a UE e.g. coding hardware can be an in-vehicle accessory or a UE e.g. communication hardware can be UE

In the example illustrated microphones 12 are an in-vehicle accessory.

The processing hardware can be an in-vehicle accessory or a UE (in-vehicle or user).

The encoding hardware can be an in-vehicle accessory or a UE (in-vehicle or user) The communication hardware can be in-vehicle UE or a user UE (in-vehicle or user).

A user may be using a device such as a smartphone (UE) and an audio capture system integrated in the car can be considered an accessory that is available using any suitable wireless or wired connectivity.

The car can provide an integrated UE, e.g., it includes a 5G modem (or the equivalent) etc. necessary components and functionalities for connectivity over the network.

In further cases, tethering may mean that mainly car UE's capabilities are used, but a phone provides the data transmission.

Spatial audio capture in a car can be enabled, or improved, by use of integrated microphone arrays. A spatial audio capture microphone array can, for example, be integrated into a rearview mirror assembly and/or at a center of the car's cabin. The microphones are preferably placed facing opposite to the driving direction to have the talkers appear predominantly in the front sector of the spatial audio scene 20, which may provide a more pleasant and natural listening experience.

The examples of FIGS. 8 and 9 illustrate the use of sectors for in-vehicle audio capture at a vehicle 60.

The audio capture is from a microphone array 12 (not illustrated) at an interior rear-view driver's mirror.

The cabin of the vehicle 60 is divided into different sector 30_i each of which is associated with a position of a person 2 (not illustrated).

The sector 30_1 is associated with a person located at the front right portion of the cabin of the vehicle 60. This sector 30_1 has a sector orientation (not illustrated) that points towards the seat at the front right of the cabin and has an angular spread 34_1. The sector 30_2 is associated with a person located at the rear right portion of the cabin of the vehicle 60. This sector 30_2 has a sector orientation (not illustrated) that points towards the seat at the rear right of the cabin and has an angular spread 34_2. The sector 30_3 is associated with a person located at the rear center portion of the cabin of the vehicle 60. This sector 30_3 has a sector orientation (not illustrated) that points towards the seat at the rear center of the cabin and has an angular spread 34_3. The sector 30_4 is associated with a person located at the rear left portion of the cabin of the vehicle 60. This sector 30_4 has a sector orientation (not illustrated) that points towards the seat at the rear left of the cabin and has an angular spread 34_4. The sector 30_5 is associated with a person located at the front left portion of the cabin of the vehicle 60 (the driver in this left-hand drive vehicle). This sector 30_5 has a sector orientation (not illustrated) that points towards the seat at the front left of the cabin and has an angular spread 34_5.

In this example, but not necessarily all examples, the sectors partially overlap. The sectors 30_1, 30_3, 30_3 are contiguous and the sector 30_2 overlaps the sectors 30_1, 30_3 and the sector 30_4 overlaps the sector 30_3, 30_5.

In this example there are five sectors, but in different use cases there might be a different number of sector. In this example there is a specific distribution of sector but in different use cases there might be a different distribution of sectors. For example, in a meeting room example the situation might be totally different. In examples, some or all of the sectors do not overlap.

The superset of sectors often covers only a portion of the 360-degree azimuth. Sectors can be understood as azimuth only, e.g., in case of planar spatial capture (e.g., planar-FOA, a “3-component” spatial audio representation) or they can be understood to cover also the height component.

In some examples, the sectors 30 are pre-determined corresponding to each seat position relative to the capture position.

In some examples, the determination of the active directions/sectors can be at least partly based on machine learning processing and/or additional data inputs. For example, the system can take into account who is present and who is the recipient or what the call relates to. For example, sectors 30 could be unevenly weighted while determining the scene orientation information. Or, e.g., the selection between a first and a second microphone array could be based on the type of call and thus expected participants of interest.

In FIG. 8, a person 2_1 is sitting in the seat at the front left of the cabin. A person 2_2 is sitting in the seat at the rear left of the cabin. The sector 30_5 is therefore an in-use sector. The sector 30_4 is therefore an in-use sector.

The sectors 30_1, 20_2, 30_3, 30_4, 30_5 are respectively illustrated in FIGS. 9A, 9B, 9C, 9D, 9E. The sector 30_5 is shaded to indicate it is an in-use sector (FIG. 9E). The sector 30_4 is shaded to indicate it is an in-use sector (FIG. 9D). The sectors 30_1, 30_2, 30_3 are not shaded indicating they are not in-use sectors (FIG. 9A, 9B, 9C).

As described previously, the capture system 10 captures the audio scene 20 using microphones 12, obtains possible positions of persons (possible talkers) for example from in-vehicle person-presence sensors 14 (e.g. weight sensors and seatbelt buckle activation detection), determines active, in use sectors 30_5, 30_4 based on the obtained positions and forms an overall active sector 30 based on the individual active, in-use sectors 30_4, 30_5. The overall active sector (sector 30) is illustrated in FIG. 10A. The sector comprises audio source 4_1 associated with person 2_1 and audio source 4_2 associated with person 2_2.

In some examples, the overall active sector (sector 30) comprises the active, in use sectors 30_5, 30_4 and any other sectors than are intermediate (between) the active, in use sectors 30_5, 30_4

As previously described there can be alternative processes for determining active or in-use sectors. For example it is possible to use audio analysis together with in-vehicle person-presence sensors and/or analysis of images captured from a camera

The assessment of active sectors and the modification of spatial audio content can be dynamically adaptive and change, for example, when a person enters a vehicle or when a person in a vehicle who has previously been silent speaks.

FIG. 10B illustrates how original spatial audio content would be rendered to a user by the spatial audio rendering apparatus 70. The audio sources 4_1, 4_2 are rendered to the front and to the right and have poor spatial separation.

The capture system 10 determines the modification that is performed on the spatial audio content to reduce a difference between the sector orientation 32 of an identified sector 30 comprising persons 4_1, 4_2 and the scene orientation 22 of the captured audio scene 20.

FIG. 11B illustrates how the modified spatial audio content would be rendered to a user by the spatial audio rendering apparatus 70. The audio sources 4_1, 4_2 are rendered to the front and center and have better spatial separation.

A first person 2_1 (audio source 4_1) will be rendered to a listener on one side of the audio scene 20 and a second person 2_2 (audio source 4_2) will be rendered to a listener on another side of the audio scene 20. In this example the first person is a driver of a vehicle and the second person is a rear passenger in a vehicle.

FIG. 11A shows the effective rotation of the audio scene 20 relative to the vehicle 60 caused by the modification.

Referring to an example of FIGS. 12A, audio capture is from a microphone array 12 (not illustrated) at a center of the cabin of the vehicle 60. A person 2-1 is sitting in the seat at the front left of the cabin. The sector 30 is an in-use sector.

As described previously, the capture system 10 captures the audio scene 20 using microphones 12, obtains possible positions of persons (possible talkers) for example from in-vehicle person-presence sensors, determines active, in use sector 30 based on the obtained positions and forms an overall active sector 30 based on the individual active, in-use sectors. The overall active sector (sector 30) is illustrated in FIG. 12A. The sector comprises an audio source 4_1 associated with person 2_1.

FIG. 12B illustrates how the original spatial audio content, before modification, would be rendered to a user by the spatial audio rendering apparatus 70. The audio source 4_1 is rendered to the rear and to the right. This could be inconvenient for a listener.

The capture system 10 determines the modification that is performed on the spatial audio content to reduce a difference between the sector orientation 32 of an identified sector 30 comprising person 2_1 and the scene orientation 22 of the captured audio scene 20.

FIG. 13B illustrates how the modified spatial audio content would be rendered to a user by the spatial audio rendering apparatus 70 when central rendering is preferred. The audio source 4_1 is rendered to the front and center. FIG. 13A shows the effective rotation of the audio scene 20 relative to the vehicle 60 caused by this modification. In this example, the offset between the orientation of the audio source 4_1 and the scene orientation 22 (not illustrated) of the audio scene 20 has been reduced to zero.

An example of FIG. 14B illustrates how the modified spatial audio content would be rendered to a user by the spatial audio rendering apparatus 70 when central rendering is not preferred. The audio source 4_1 is rendered to the front and right. FIG. 14A shows the effective rotation of the audio scene 20 relative to the vehicle 60 caused by this modification. In this example, the offset between the orientation of the audio source 4_1 and the scene orientation 22 (not illustrated) of the audio scene 20 has been reduced to a non-zero value. The audio source 4 has been moved closer to the front but maintained on its original side.

In some examples, the user (the listener) determines whether the off-set value is zero or not zero. In some examples, the user (the listener) determines a magnitude of the non-zero value.

FIGS. 10A, 10B, 11A, 11B, 12A, 12B, 13A, 13B, 14A, 14B illustrate examples of conversational spatial audio capture originating from an in-car environment and terminating in binaural headphone playback via headphones, which may or may not be head-tracked headphones. Depending on the talker 2 configuration in the vehicle 60, the default format orientation can provide a spatially unbalanced rendering. While this is a correct rendering as such, providing a modified spatial audio rendering with more spatially balanced content representation allows for a more natural conversation. Improving balance of spatial scene rendering is particularly important for users who do not have head-tracking capability (or other controls) or who are in an environment where changing listening orientation, e.g., rotating their head for an extended period is undesirable or not possible. Thus, it is better if the default scene could be rendered to the user automatically in a modified, spatially balanced manner. It may also be desirable to maintain the integrity of the audio scene (maintain the relative positioning between audio sources 4).

FIGS. 15A and 15C illustrates an example of rendering an audio scene 20 comprising an audio source using headphones 52 (for example, binaural headphones) without head-tracking. The audio source 4 has a fixed orientation to a listener's head and headphones 52.

FIGS. 15A and 15B illustrates an example of rendering an audio scene 20 comprising an audio source 4 using headphones 52 (for example, binaural headphones) with head-tracking. The audio source 4 is rendered with a fixed orientation relative to the real-world. The audio source 4 is rendered with a counter-rotation relative to the listener's head and headphones 52.

When head-tracking is performed the perception is that the audio scene 20 remains stationary (fixed to the real world). This is achieved for headphones 52 by measuring the rotation of a listener's head and then rotating the audio scene 20 in in the opposite sense by the same amount. A listener rotating their head to the right correspondingly “moves” all audio sources to the left in the binaural percept. This can be called, e.g., head or user orientation.

In perspective-mediated virtual reality, for example first person perspective-mediated reality, a user change in a position of a virtual listener within an audio scene changes the positions of the audio sources 4 relative to the virtual listener which changes the virtual audio scene rendered to the user. A portion of the spatial audio content is selected by a current point-of-view of the user (point-of-view of the virtual user). That portion of the spatial audio content is rendered to the user. The user, by changing their own point-of-view, can change the point-of-view of the virtual user to appreciate different aspects of the audio space. In some examples, the change in the point-of-view of the user is achieved by varying only the user's orientation and in other examples it is achieved by changing the user's orientation and/or the user's location. The spatial audio content can therefore support 3DoF, 3DoF+, and 6DoF.

FIG. 16 illustrates an implementation of an IVAS decoder 48 including the integrated IVAS renderer at a rendering apparatus 70.

The IVAS decoder 48 with the integrated renderer provides means for re-orientation of an audio scene for head-tracking and in other scenarios e.g. via external orientation information 502.

The determined modification previously described can be provided in the form of modification information to the decoder/renderer 48 as external orientation information 502. The external orientation information 502 input supports IVAS scene orientation update signaling.

In the illustrated example, there may be multiple modes of operation 503. A first mode corresponds to a provision of reference data 204 indicating a front direction for the rendering. A second mode can correspond to averaging a reference, e.g., a mechanism for removing slowly evolving orientation changes from the head-tracking data. A third mode may be a default mode or regular head-tracking mode, which does not apply any reference data or averaging for the head-tracking or orientation data 206.

A head orientation flag 508 can be used to enable, disable, or freeze head-tracking.

The head-tracker processing 510 determines a rotation of an audio scene based on head orientation data 506 and this is applied by a rotator 514 if head tracking is enabled.

The output from the rotator 514 is rendered 50 as output audio, for example, binaural audio over headphones. The final orientation data 212, from the rotator 514, may also be provided from the renderer 48 to be used as needed.

External orientation information 502 is provided to the renderer 48 in addition to head-tracking or orientation data 506 (if any).

The rotator functionality 514 is detached from the head-tracker processing 510. This is because the external orientation data 502 is combined with the head-tracker processing 510 output by an orientation data combiner 516.

The orientation data combiner 516 may further accept an external orientation flag 509 as a command to enable, disable, or freeze application of the external orientation information 502.

The external orientation 502 may change significantly at any update, and therefore in some cases it can be desirable to smooth this change. For this reason, an interpolation functionality 518 can be provided. A new intermediate orientation, on a smooth transition from an initial orientation to a final orientation, can be set for each frame. Thus, the renderer 48 calculates at each frame the target orientation depending on the current orientation, the external orientation 502, and the frame number.

FIG. 17 illustrates an example of a controller 400 suitable for use in an apparatus 10 or apparatus 70. Implementation of a controller 400 may be as controller circuitry. The controller 400 may be implemented in hardware alone, have certain aspects in software including firmware alone or can be a combination of hardware and software (including firmware).

As illustrated in FIG. 17 the controller 400 may be implemented using instructions that enable hardware functionality, for example, by using executable instructions of a computer program 406 in a general-purpose or special-purpose processor 402 that may be stored on a computer readable storage medium (disk, memory etc.) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 10 when loaded into the processor 402. The computer program instructions, of the computer program 406, provide the logic and routines that enables the apparatus to perform the methods illustrated in the accompanying Figs. The processor 402 by reading the memory 404 is able to load and execute the computer program 406.

In at least some examples, the apparatus 10 comprises:
at least one processor 402; and
   at least one memory 404 including computer program code,
   the at least one memory storing instructions that, when executed by the at least one processor 402, cause the apparatus at least to:
identify a sector 30 of an audio scene 20, wherein the sector 30 comprises one or more persons 2; and
determining a modification to a spatial audio content, for rendering the audio scene 20, to reduce an angular offset 40 between a scene orientation 22 of the audio scene 20 and a sector orientation 32 of the identified sector 30.

As illustrated in FIG. 18, the computer program 406 may arrive at the apparatus 10 or apparatus 70 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 10 may propagate or transmit the computer program 406 as a computer data signal.

Computer program instructions for causing an apparatus 10 to perform at least the following or for performing at least the following:
identify a sector 30 of an audio scene 20, wherein the sector 30 comprises one or more persons 2; and
determining a modification to a spatial audio content, for rendering the audio scene 20, to reduce an angular offset 40 between a scene orientation 22 of the audio scene 20 and a sector orientation 32 of the identified sector 30.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The apparatus 10 can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1-16. (canceled)

17. An apparatus comprising:
at least one processor; and
at least one memory storing instructions that, when executed by the at least one processor, cause the apparatus at least to:
identify a sector of an audio scene, wherein the sector comprises one or more persons and has an angular spread that does not extend beyond a spatial distribution of persons in the audio scene; and
determine a modification to a spatial audio content, for rendering the audio scene, to reduce an angular offset between a scene orientation of the audio scene for rendering and a sector orientation of the identified sector.

18. An apparatus as claimed in claim 17, wherein the scene orientation of the audio scene for rendering is defined by a front direction for rendering the audio scene and the sector orientation of the identified sector is defined by a midline of the sector.

19. An apparatus as claimed in claim 17, wherein identifying a sector of an audio scene comprising one or more persons comprises identifying the sector as an active sector and the apparatus is further caused to process audio content captured from the audio scene to identify a sector of the audio scene that actively includes speech audio sources.

20. An apparatus as claimed in claim 17, wherein identifying a sector of an audio scene comprising one or more persons comprises identifying the sector as an active sector and the apparatus is further caused to receive an input from one or more person-presence-sensors for the audio scene that detect active physical presence of one or more persons in the sector of the audio scene.

21. An apparatus as claimed in claim 17, wherein identifying a sector of an audio scene comprising one or more persons comprises identifying the sector as an active sector and the apparatus further comprises one or more in-vehicle person-presence-sensors configured to detect active physical presence of one or more persons in the sector of the audio scene, wherein the audio scene is an in-vehicle audio scene.

22. An apparatus as claimed in claim 21, wherein the one or more in-vehicle person-presence-sensors comprise at least one of vehicle seat weight sensors or vehicle seatbelt buckle activation sensors.

23. An apparatus as claimed in claim 17, wherein determining a modification to a spatial audio content, for rendering the audio scene, to reduce an angular offset between a scene orientation of the audio scene and a sector orientation of the identified sector comprises rotating the audio scene.

24. An apparatus as claimed in claim 17, wherein the apparatus is further caused to modify the spatial audio content for rendering the audio scene, wherein the spatial audio content comprises at least a first audio source at a first orientation relative to the scene orientation of the audio scene and a second audio source at a second orientation relative to the scene orientation of the audio scene, wherein an angular offset between the first orientation and the scene orientation of the audio scene and an angular offset between the second orientation and the scene orientation of the audio scene are reduced.

25. An apparatus as claimed in claim 24, wherein the spatial audio content is modified, such that the scene orientation of the audio scene is mid-way between the first orientation and the second orientation.

26. An apparatus as claimed in claim 17, wherein determining a modification to a spatial audio content, for rendering the audio scene, to reduce an angular offset between a scene orientation of the audio scene and a sector orientation of the identified sector comprises modifying the spatial audio content for rendering the audio scene, to optimize a cost function that favors a spaced, distribution of orientations of persons about the scene orientation of the audio scene.

27. An apparatus as claimed in claim 17, wherein determining a modification to a spatial audio content, for rendering the audio scene, to reduce an angular offset between a scene orientation of the audio scene and a sector orientation of the identified sector comprises at least one of:
determining a modification to a spatial audio content, for rendering the audio scene, to reduce to zero an angular offset between the scene orientation of the audio scene and the sector orientation of the identified sector;
or
determining a modification to a spatial audio content, for rendering the audio scene, to reduce to a non-zero value an angular offset between the scene orientation of the audio scene and the sector orientation of the identified sector.

28. An apparatus as claimed in claim 17, wherein microphones used for capturing the spatial audio from an audio scene are fixed relative to the audio scene and wherein determining a modification to a spatial audio content, for rendering the audio scene, to reduce an angular offset between a scene orientation of the audio scene and a sector orientation of the identified sector comprises virtually re-orienting the microphones.

29. An apparatus as claimed in claim 17, wherein the apparatus is further caused to transfer a modification record of the modification on the spatial audio content to reduce a difference between the orientation of the audio source and the scene orientation of an audio scene, to enable the modification to be done or undone.

30. A method comprising:
identifying a sector of an audio scene, wherein the sector comprises one or more persons and has an angular spread that does not extend beyond a spatial distribution of persons in the audio scene; and
determining a modification to a spatial audio content, for rendering the audio scene, to reduce an angular offset between a scene orientation of the audio scene for rendering and a sector orientation of the identified sector.

31. A method as claimed in claim 30, wherein the scene orientation of the audio scene for rendering is defined by a front direction for rendering the audio scene and the sector orientation of the identified sector is defined by a midline of the sector.

32. A method claimed in claim 30, wherein identifying a sector of an audio scene comprising one or more persons comprises identifying the sector as an active sector and processing audio content captured from the audio scene to identify a sector of the audio scene that actively includes speech audio sources.

33. A method as claimed in claim 30, wherein identifying a sector of an audio scene comprising one or more persons comprises identifying the sector as an active sector and receiving an input from one or more person-presence-sensors for the audio scene that detect active physical presence of one or more persons in the sector of the audio scene.

34. A method as claimed in claim 30, wherein identifying a sector of an audio scene comprising one or more persons comprises identifying the sector as an active sector and detecting active physical presence of one or more persons in the sector of the audio scene, wherein the audio scene is an in-vehicle audio scene.

35. A method as claimed in claim 30, wherein determining a modification to a spatial audio content, for rendering the audio scene, to reduce an angular offset between a scene orientation of the audio scene and a sector orientation of the identified sector comprises rotating the audio scene.

36. A non-transitory computer readable medium comprising program instructions stored thereon for performing at least the following:
identifying a sector of an audio scene, wherein the sector comprises one or more persons, and has an angular spread that does not extend beyond a spatial distribution of persons in the audio scene; and
determining a modification to a spatial audio content, for rendering the audio scene, to reduce an angular offset between a scene orientation of the audio scene for rendering and a sector orientation of the identified sector.
